(19) United States
(12) Patent Application Publication
(10) Pub. No.: US 2002/0101183 A1
(43) Pub. Date: Aug. 1, 2002

(54) Switching device

(75) Inventors: Petrus Wilhelmus Fransiscus Bens, Oss (NL); Franciscus Hubertus Theodorus Lammers, Oss (NL)

Correspondence Address: U.S. Philips Corporation, 580 White Plains Road, Tarrytown, NY, 10591, US

(73) Assignee: Koninklijke Philips Electronics N . V .

(21) Appl. No.: 09/931,207

(22) Filed: Aug. 16, 2001

(30) Foreign Application Priority Data
Aug. 17, 2000 (EP) 002028868

(51) Int. Cl. H05B 37/02

(52) U.S. Cl. 315/224; 315/225

(57) ABSTRACT

A switching arrangement intended to operate a high-pressure discharge lamp at a voltage having successive periods of opposite polarity. The switching arrangement is provided with:

input terminals for connecting a power supply source,

output terminals for connecting the lamp to be operated,

a switch mode power supply and control means for controlling the switch mode power supply, and

means for forming a lamp signal corresponding to the voltage across the lamp.

According to the invention, the switching arrangement is provided with means for detecting Direct current through and/or DC voltage across the high-pressure discharge lamp.

The invention relates to a switching device for operating a high-pressure discharge lamp at a voltage having successive periods of opposite polarity, comprising:

input terminals for connecting a power supply source,

output terminals for connecting the lamp to be operated,

a switch mode power supply and control means for controlling the switch mode power supply,

means to form a lamp signal corresponding to the voltage across the lamp.

The invention also relates to a projection apparatus comprising a switching device which can suitably be used to operate a high-pressure discharge lamp.

A switching device of the type mentioned in the opening paragraph is known from WO 00/36882 (D98161). The known switching device comprises means which enable the power supplied to the lamp to be controlled by means of a microprocessor in such a way that the shape of the current through the lamp can be adjusted for each period of the supply voltage having successive periods of opposite polarity. The shape of the current flowing through the lamp is adjusted on the basis of the lamp signal corresponding to the voltage across the lamp. In this manner, flicker and unstable burning of the lamp can be substantially counteracted. The known switching device can particularly suitably be used to operate a high-pressure discharge lamp in a projection system, such as a projection television receiver.

A drawback of the known switching device, however, resides in that it is very complex and, in addition, offers no protection against failure of the lamp as a result of, for example, asymmetric operation of the lamp over a long period of time.

It is an object of the invention to provide a measure to counteract said drawback. This is achieved, by means of a switching device of the type mentioned in the opening paragraph which is characterized in accordance with the invention in that the switching device comprises means for detecting a Direct current through or a DC voltage across the high-pressure discharge lamp.

An advantage of the switching device in accordance with the invention resides in that undesirable, long-term asymmetry in the operation of the lamp can be detected in a comparatively simple way. Asymmetric operation of the lamp is based on the fact that the lamp effectively carries a DC voltage and/or a Direct current over a length of time covering at least two successive periods of opposite polarity. The detection of a Direct current through or a DC voltage across the high-pressure discharge lamp preferably takes place by means of the lamp signal. This has the advantage that the complexity of the switching device remains limited.

In an advantageous embodiment of the switching device in accordance with the invention, the formation of the lamp signal relates to time-sequential voltage detections, and the means for carrying out the detection include comparison means for comparing successive voltage detections. In this manner, a voltage difference between successive voltage detections can be advantageously established.

Preferably, the switching device is provided with a commutator and the lamp signal is formed between the output of the switch mode power supply and said commutator. This has the important advantage that improper functioning of the commutator is also detected. Improper functioning of the commutator, in general as a result of improper switching of one of the commutator switches, is an important cause of Direct current or DC voltage operation of the lamp. The possibility of monitoring the proper functioning of the commutator by means of thermal detection is impracticable, taking into consideration the fact that a commutator in a switching circuit for a high-pressure discharge lamp often comprises 4 switching elements, because this thermal detection would require at least 2, but preferably 4, thermal detection circuits, which would result in a very complex procedure.

In an advantageous embodiment of the switching device, the detection means can suitably be used to carry out an algorithm wherein, after each voltage detection, a counting register is kept on the basis of an outcome of a comparison between the established voltage difference and an average voltage and, upon exceeding in the counting register a threshold value, a control signal is generated for switching the switch mode power supply to a stand-by mode.

Surprisingly, it has been found that as regards the successive voltage detections, a voltage detection in each period of the successive periods of opposite polarity is sufficient. As a result, the switching device remains comparatively simple. If the lamp signal to be detected contains comparatively much noise, then it may be advantageous to employ a filter circuit in the switching device, for example in the form of an analog low-pass filter. Another possible filter technique is a digital filter technique, for example for averaging out 2 or more voltage detections per period of the successive periods of opposite polarity.

Preferably, the average voltage is formed from a moving average of voltage detections in the last 4 successive periods of opposite polarity. This has the important advantage that the average voltage, which is used as a reference value, is related to each individual lamp. As a result, a spread in properties between individual lamps has no appreciable effect on the reliable functioning of the switching device.

In experiments it has been found that if the established voltage difference exceeds 50% of the average voltage, then this voltage difference can be used as a measure of the occurrence of a Direct current through or a DC voltage across the lamp. In such a case, an increase of the counting register by one enables the frequency of the direct current flowing through or the DC voltage applied across the lamp to be monitored. Preferably, the counting register is reduced by one if the established voltage difference is equal to or smaller than 50% of the average voltage. In this manner, the influence of accidental fluctuations in the current through or the voltage across the lamp is substantially eliminated in a simple, reliable manner.

These and other aspects of the invention will be apparent from and elucidated with reference to the embodiment(s) described hereinafter.

In the drawings:

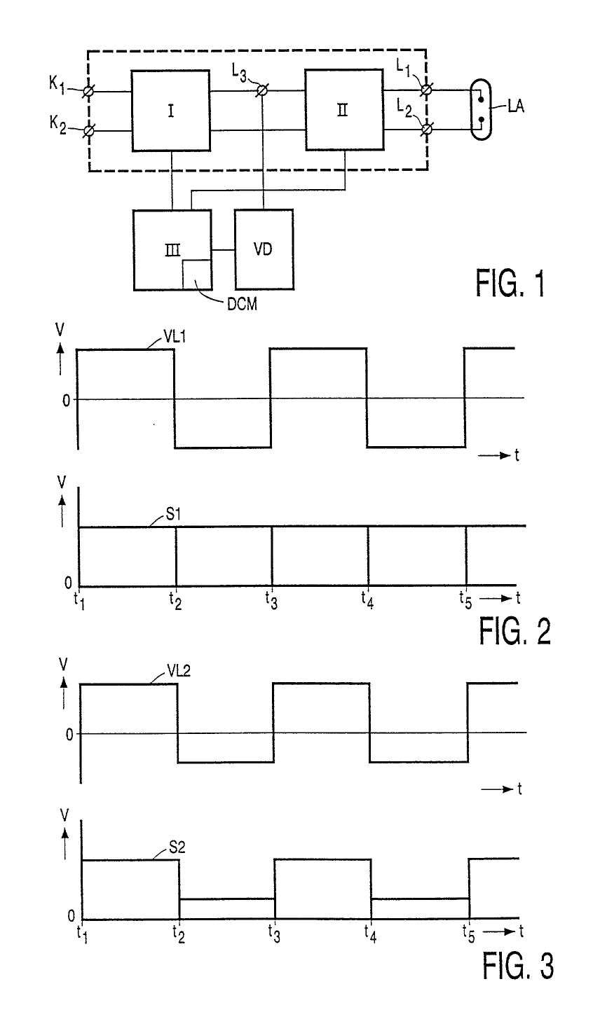

FIG. 1 diagrammatically shows a switching device in accordance with the invention,

FIG. 2 shows a voltage diagram of voltages at nominal operation,

FIG. 3 shows a voltage diagram of voltages at Direct current operation, and

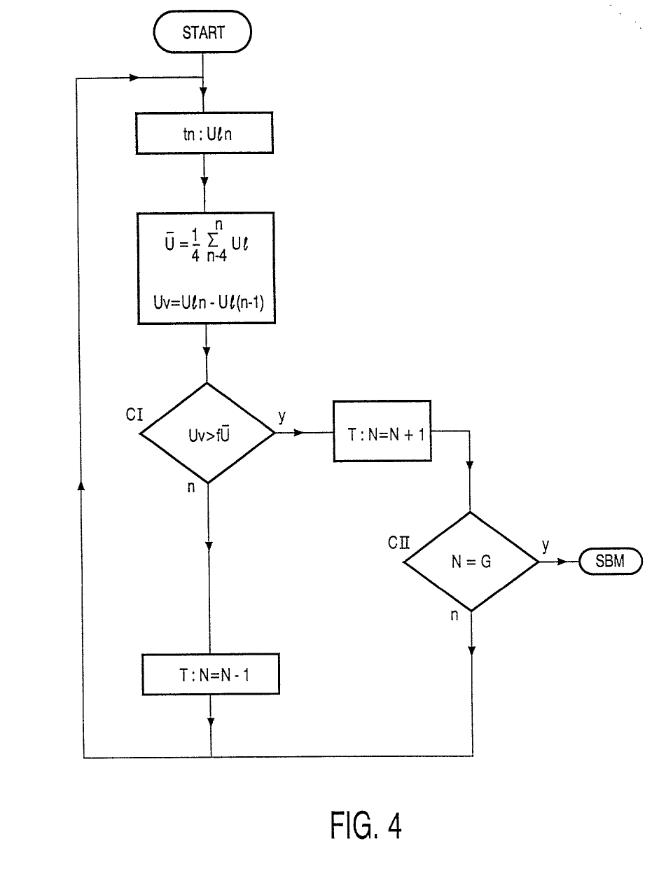

FIG. 4 diagrammatically shows an algorithm used in the switching device in accordance with FIG. 1.

FIG. 1 shows a switching device which is suitable for operating a high-pressure discharge lamp at a voltage having successive periods of opposite polarity, wherein K1, K2 are input terminals for connecting a power supply source, and L1, L2 are output terminals for connecting the high-pressure discharge lamp LA to be operated. I represents a switch mode power supply, II represents a commutator and III represents control means for controlling the switch mode power supply and the commutator. The switching device further comprises means VD for forming a lamp signal corresponding to the voltage across the lamp. The switching device also comprises means DCM for detecting a Direct current through or a DC voltage across the high-pressure discharge lamp.

The means VD for forming the lamp signal are connected to a connection point L3 between the output of the switch mode power supply and the commutator. As a result, the lamp signal is formed as a voltage detection at the output of the switch mode power supply.

In a practical embodiment of the switching device in accordance with the example described hereinabove, this switching device can suitably be used to operate a lamp of the type UHP132W, manufactured by Philips. The commutator comprises 4 MOSFET switches, which are rendered conducting and non-conducting in pairs at regular intervals of time. In the above-described example, switching of the commutator switches takes place at a constant frequency, for example 90 Hz. Alternatively, the switching of the commutator is synchronized with a video signal from the projection system by means of a control signal. The switch mode power supply is a Buck converter or (step-) down converter provided with a switching element which is rendered conducting and non-conducting with a high frequency by a control signal originating from the control means, for example a PWM. The Buck converter or (step-) down converter may be preceded by a boost converter or (step-) up converter. A resistive voltage divider which is connected to the connection point L3 forms part of the means VD for forming a lamp signal corresponding to the voltage across the lamp. The part of the means VD which forms the lamp signal as time-sequential voltage detections, in the case described, of the voltage at a tap on the resistive voltage divider, forms part of a programmable IC 80C51 of the type 83747, manufactured by Philips. The programmable IC, which is provided with an algorithm as described hereinbelow, also forms the means DCM for detecting a direct current through or a DC voltage across the high-pressure discharge lamp. The IC also forms part of the control means III. The means DCM are responsible for periodically comparing successive voltage detections.

For a counting register use is made of a RAM memory accommodated in the IC. In the practical example, the switch mode power supply is switched to a standby mode as soon as the counting register reaches 750. In the standby mode of the switch mode power supply, the control means make sure that the voltage at the output of the switch mode power supply is so low that a discharge cannot be maintained in the lamp.

In FIG. 2 and FIG. 3, the time is plotted along the horizontal axis and a voltage is plotted along the vertical axis. In the voltage diagram shown in FIG. 2, VL1 shows the variation of the voltage across the connected lamp if asymmetric operation of the lamp does not take place. At the instants t1, t2, t3, t4 and t5, commutation of the commutator takes place, causing the voltage to have successive periods of opposite polarity. Thus, the intervals between t1 and t2 and between t3 and t4 form periods having a positive polarity, while the intervals between t2 and t3 and between t4 and t5 are periods of negative polarity. The periodical voltage detection by the means VD results in the formation of a lamp signal having a variation in accordance with S1.

In FIG. 3, VL2 forms, in a similar manner, the variation of the voltage across the connected lamp if asymmetric operation of the lamp takes place, in which case a direct current flows through the lamp or a DC voltage is applied across the lamp. In this case, the shape of the lamp signal of the voltage detection corresponds to S2.

The algorithm with which the programmable IC of the example described herein is provided is diagrammatically shown in FIG. 4. After the lamp has been ignited and a stable burning condition has been achieved, indicated by means of START, at instant tn voltage detection takes place, the outcome of which is indicated by means of Uln. Subsequently, an average voltage \overline{U} is calculated from the last 4 results Uln through Ul(n−4), and the difference in voltage between Uln and Ul(n−1) is calculated. Subsequently, comparison means carry out a comparison CI to determine whether the difference in voltage Uv exceeds a fraction f, for example 50%, of the average voltage \overline{U}. If so, a counting register T is increased by 1. In a next comparison CII, it is subsequently determined whether the contents of the counting register has reached a limiting value G. If so, the switch mode power supply is switched into a standby mode SBM. If not, a subsequent voltage detection is carried out. If the comparison CI reveals that Uv is smaller than or equal to the fraction f of the average voltage \overline{U}, then the contents of the counting register T is reduced by 1 and a subsequent voltage detection is carried out.

The example described herein forms part of a projection system, in particular a light valve projector.

1. A switching device for operating a high-pressure discharge lamp at a voltage having successive periods of opposite polarity, comprising:
input terminals for connecting a power supply source,
output terminals for connecting the lamp to be operated,
a switch mode power supply and control means for controlling the switch mode power supply,
means to form a lamp signal corresponding to the voltage across the lamp. characterized in that the switching device comprises means for detecting a Direct current through or a DC voltage across the high-pressure discharge lamp.

2. A switching device as claimed in claim 1, characterized in that the detection of a Direct current through or a DC voltage across the high-pressure discharge lamp takes place by means of the lamp signal.

3. A switching device as claimed in claim 1, characterized in that the formation of the lamp signal relates to time-sequential voltage detections, and the means for carrying out the detection include comparison means for comparing successive voltage detections.

4. A switching device as claimed in claim 1, characterized in that the comparison means are suitable to establish a voltage difference between the successive voltage detections.

5. A switching device as claimed in claim 2, characterized in that the switching device is provided with a commutator, and the formation of the lamp signal takes place between the output of the switch mode power supply and the commutator.

6. A switching device as claimed in claim 4, characterized in that the detection means can suitably be used to carry out an algorithm wherein, after each voltage detection, a counting register is kept on the basis of an outcome of a comparison between the established voltage difference and an average voltage and, upon exceeding in the counting register a threshold value, a control signal is generated for switching the switch mode power supply to a stand-by mode.

7. A switching device as claimed in claim 1, characterized in that the successive voltage detections take place by means of a voltage detection in each period of the successive periods of opposite polarity.

8. A switching device as claimed in claim 7, characterized in that the average voltage is formed from a moving average of voltage detections in the last 4 successive periods of opposite polarity.

9. A switching device as claimed in claim 6 or 8, characterized in that the counting register is increased by one if the established voltage difference exceeds 50% of the average voltage.

10. A switching device as claimed in claim 6 or 8, characterized in that the counting register is reduced by one if the established voltage difference is equal to or smaller than 50% of the average voltage.

11. A projection apparatus provided with a switching device which can suitably be used to operate a high-pressure discharge lamp as claimed in any one of the preceding claims.
